(19) United States
(12) Patent Application Publication
(10) Pub. No.: US 2010/0039032 A1
(43) Pub. Date: Feb. 18, 2010

(54) High Pressure Discharge Lamp

(75) Inventor: Dieter TRYPKE, Falkensee (DE)

Correspondence Address: COHEN, PONTANI, LIEBERMAN & PAVANE LLP, 551 FIFTH AVENUE, SUITE 1210, NEW YORK, NY, 10176, US

(73) Assignee: OSRAM Gesellschaft mit beschrankter Haftung, Munich (DE)

(21) Appl. No.: 12/478,518

(22) Filed: Jun. 4, 2009

(30) Foreign Application Priority Data
Jun. 5, 2008 (DE) 20 2008 007 518.1

(51) Int. Cl. H01J 61/26; H01J 9/38

(52) U.S. Cl. 313/561; 445/41

(57) ABSTRACT

The frame that holds a discharge vessel in an outer bulb is manufactured from Nb or Zr, said frame acting as getter in an evacuated outer bulb.

### RELATED APPLICATIONS

This application claims the priority of German patent application no. 20 2008 007 518.1 filed Jun. 5, 2008, the entire disclosure of which is hereby incorporated by reference.

### FIELD OF THE INVENTION

The invention is related to high pressure discharge lamps having a ceramic discharge vessel or else silica glass vessel for general lighting.

### PRIOR ART

DE 199 51 445 discloses a high pressure discharge lamp in the case of which a Nb getter is mounted on an electrode shaft in the discharge volume. EP 790 639 discloses a high pressure discharge lamp in the case of which Nb—Zr is used as getter.

EP 251 436 discloses a sodium high pressure lamp in the case of which a Ba getter is fitted in the outer bulb and a getter including Nb is introduced in the discharge vessel.

### SUMMARY OF THE INVENTION

One object of the present invention is to provide a high pressure discharge lamp in which local heating of the discharge vessel is largely avoided.

A multiplicity of discharge lamps make use of a vacuum in the outer bulb. This vacuum serves the purpose, on the one hand, of operating the lamps in a thermally stable fashion, the point being that a fill gas in an outer bulb, for example nitrogen, would cool the lamp in operation. On the other hand, the vacuum protects lamp components that, when in contact with a fill gas, either oxidize, corrode or become brittle, and this leads to premature failure of the lamp.

One aspect of the invention relates to a lamp frame that has a getter action. It has emerged that a lamp frame made from niobium, niobium/zirconium, or Zr operates as a getter in a lamp starting from temperatures of at least 230° C. The lamp frame or a component of the bushing into the burner is brought up adequately close to the burner in this case in order to reach the required temperature. In the extreme case, it is even possible for the lamp frame and discharge vessel to touch one another. The frame or component is activated by the thermal radiation of the burner. An existing vacuum is maintained or improved thereby.

If use is made of a lamp frame having getter action, there is, moreover, a cost saving in the building of the lamp in some circumstances, since it is possible to dispense with additional components (for example zirconium getters) and additional manufacturing methods/devices.

It is known per se to introduce into the outer bulb getters that maintain or even improve the vacuum. Known lamps make use in the outer bulb of a zirconium getter that is welded to the lamp frame or to the burner. The vacuum technique that is used for setting the outer bulb vacuum usually reaches a vacuum in the range of 10⁻² mbar. The desired vacuum is then set in the range of 10⁻⁴ mbar with the aid of the getter activation.

An embodiment of the invention involves the possibility of producing the required outer bulb vacuum in the range of 10⁻⁴ mbar without an additional getter plate (zirconium getter).

Lamps with a ceramic discharge vessel already make use of a lamp frame made from niobium or niobium/zirconium. Up until now, a plate with a zirconium getter has been welded onto said lamp frame during the course of manufacture, and activated. It has now been demonstrated that it is possible to dispense with this additional lamp component. If the niobium niobium/zirconium frame or another niobium niobium/zirconium component that is fastened on the bushings of the burner is guided only sufficiently closely past the burner, and this component is exposed to a temperature ≧230° C., this component develops a getter action. By contrast with the zirconium getter that improves the outer bulb vacuum from 10⁻² mbar to 10⁻⁴ mbar directly after the activation of the outer bulb vacuum, the getterable lamp frame requires a few burning hours until a corresponding outer bulb vacuum is likewise established. After 100 hours of burning life, an identical outer bulb vacuum is measured, irrespective of whether the lamp has a separate zirconium getter or only a getterable lamp frame.

The discharge vessel typically consists of ceramic containing aluminum, such as PCA or else YAG, AlN, or AlYO3. However, it can also consist of silica glass. Both are known per se from the prior art. Nor is there any particular limitation on the choice of fill.

### BRIEF DESCRIPTION OF THE DRAWINGS

The aim below is to explain the invention in more detail with the aid of a plurality of exemplary embodiments. In the figures:

FIG. 1 shows a high pressure discharge lamp having a discharge vessel and getter according to the prior art;

FIG. 2 shows a high pressure discharge lamp having a discharge vessel, but without getter.

### PREFERRED EMBODIMENT OF THE INVENTION

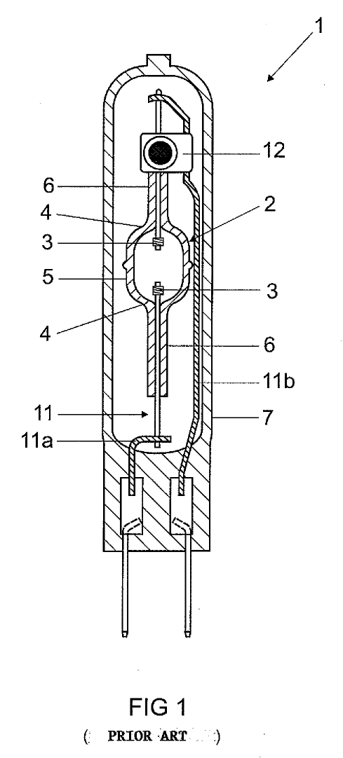

FIG. 1 shows a schematic of a metal halide lamp 1. It comprises a discharge vessel 2 made from ceramic into which two electrodes 3 are introduced. The discharge vessel has a central part 5 and two ends 4. Seated at the ends are two seals 6, which are designed here as capillaries. The discharge vessel and the seals are preferably produced in an integral fashion from a material such as PCA.

The discharge vessel 2 is surrounded by an evacuated outer bulb 7. The discharge vessel 2 is held in the outer bulb by means of a frame 11 that includes a short bushing 11a and a long bushing 11b.

The frame is manufactured from Nb wire or Mo wire or the like. In the particular case of a 70 W lamp with metal halide fill the diameter of the frame wire is typically 0.5 to 1.5 mm. A getter plate 12 with Zr is fastened on the frame.

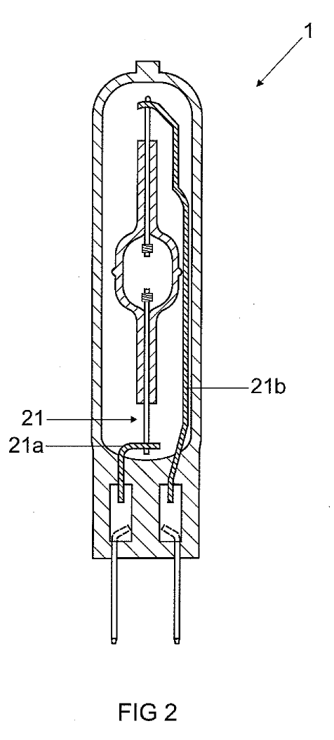

FIG. 2 shows a schematic of a similar metal halide lamp 1. It is identical in design to the first lamp. However, it is important here that the frame 21, that is to say both the short wire 21a and the long wire 21b, is manufactured from niobium, zirconium, or a Nb/Zr alloy. However, it is possible for only the long frame wire 21b to be manufactured from this material.

Furthermore, it is important that the spacing between the discharge vessel and the long frame wire 21b be dimensioned so closely, advantageously in the region of the bulge 5, that the frame wire 21b reaches a temperature of at least 230° C. in operation. The diameter of the frame wire is unchanged.

The frame is preferably made from niobium wire to which at least 0.1 mol % of Zr has been added.

In lamps with a base at one end, in the case of which the long bracket wire 21b is led back directly along the discharge vessel, there is no need to undertake to change the frame arrangement in order to be able to dispense with the additional getter in the evacuated outer bulb. By contrast, in the case of lamps with bases at both ends, there is an explicit need to ensure that a frame wire is guided up closely enough to the discharge vessel. Of course, it is also sufficient when only a portion of the frame, for example one of the two wires or a wire segment that is exposed to a sufficiently high temperature is formed from the gettering material, specifically Nb or Zr or an alloy thereof. The remaining portion of the frame can consist of other material, this being valid, in particular, for the short frame wire in a lamp with a base at one end.

Depending on the volume of the outer bulb, more or less time is required until the desired vacuum is established without extra getter plates. However, in each case the time is always only in the region of a few hours.

The typical, most effective spacing of the frame portion from the discharge vessel lies in the range of 0.2 to 2 mm.

The lamp can include electrodes, but need not do so. The fill can contain metal halides, but need not do so. The lamp can also be a sodium high pressure lamp.

Tables 1 and 2 show a comparison of the development of the vacuum in the case of lamps according to the prior art, and of inventive lamps in the case of which the frame acts as a getter. It is to be seen that the frame as getter requires only a little more time in order, however, finally to ensure an equally good vacuum.

TABLE 1

| | | | |
|---|---|---|---|
| 0 | hr | 3 × 10⁻⁴ | mbar |
| 1 | hr | 4 × 10⁻⁴ | mbar |
| 25 | hr | 6 × 10⁻⁴ | mbar |
| 100 | hr | 1, 1 × 10⁻³ | mbar |

TABLE 2

| | | |
|---|---|---|
| 0 | hr | 3 × 10⁻² mbar |
| 1 | hr | 2 × 10⁻⁴ mbar |
| 25 | hr | 5 × 10⁻⁴ mbar |
| 100 | hr | 9 × 10⁻⁴ mbar |

1. A high pressure discharge lamp having a discharge vessel that surrounds a discharge volume, electrodes extending into the discharge volume enveloped by the discharge vessel, and a fill that contains metal halides accommodated in the discharge volume, the discharge vessel being surrounded by an outer bulb and being held therein by a frame, wherein the outer bulb is evacuated and a getter in the outer bulb serves for setting and maintaining the vacuum, a frame comprising at least partially or in some portions, Nb, Zr or an alloy of these two metals, and that is formed such that it is exposed in operation to a temperature of at least 230° C. at least in a region that consists of Nb, Zr, or their alloy, with the frame itself acting as the getter.

2. The high pressure discharge lamp as claimed in claim 1, wherein the outer bulb is sealed at one end, the frame having a long bracket wire that is led back from the end of the outer bulb remote from the base to the closure of the outer bulb.

3. The high pressure discharge lamp as claimed in claim 1, wherein the minimum spacing between frame and discharge vessel is at most 2 mm and preferably lies in the range 0.2 to 2 mm.

4. The high pressure discharge lamp as claimed in claim 1, wherein the lamp has a longitudinal axis, and the frame is led along the discharge vessel over at least an axial length of 5 mm such that its operating temperature is at least 230° C.

5. A method for producing a high pressure discharge lamp having a frame wire made from Nb, Zr, or an alloy thereof as getter, comprising:
providing the high pressure discharge lamp with a discharge vessel that surrounds a discharge volume, electrodes extending into the discharge volume enveloped by the discharge vessel, and a fill that contains metal halides accommodated in the discharge volume, the discharge vessel being surrounded by an outer bulb and being held therein by a frame, the outer bulb being evacuated; and
forming the frame such that it is exposed in operation to a temperature of at least 230° C., at least in a region that consists of Nb, Zr, or their alloy, wherein the frame acts as the getter for setting and maintaining a vacuum in the outer bulb.
